(19) United States
(12) Patent Application Publication
(10) Pub. No.: US 2009/0048889 A1
(43) Pub. Date: Feb. 19, 2009

(54) Manufacturing portfolio flexibility planning

(75) Inventors: Jorge F. Arinez, Rochester Hills, MI (US); Stephan R. Biller, Birmingham, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC, Detroit, MI (US)

(21) Appl. No.: 11/839,727

(22) Filed: Aug. 16, 2007

(51) Int. Cl. G06Q 10/00; G06F 17/18

(52) U.S. Cl. 705/8

(57) ABSTRACT

A method, computer program product, and system for manufacturing portfolio flexibility planning are provided. The method includes matching production needs to manufacture a plurality of products with manufacturing capabilities of plants in a manufacturing portfolio. The method also includes developing flexibility scenarios for a manufacturing portfolio flexibility plan. The flexibility scenarios include manufacturing related products at one or more identified plants in the manufacturing portfolio. The method further includes performing statistical analysis of the flexibility scenarios, and evaluating a result of the statistical analysis to determine whether the flexibility scenarios meet a success criterion. The method additionally includes updating the manufacturing portfolio per the manufacturing portfolio flexibility plan when the flexibility scenarios meet the success criterion, and outputting the manufacturing portfolio flexibility plan.

### BACKGROUND OF THE INVENTION

The present disclosure relates to manufacturing planning and more particularly to manufacturing portfolio flexibility planning.

Modern manufacturers often make a variety of products in multiple plants. Larger global manufacturers with more products and manufacturing facilities face many challenges in making decisions rapidly in response to changes in market demands, both domestically and internationally. To remain competitive in the global economy, manufacturers typically strive to minimize their manufacturing footprint, i.e., total number of manufacturing facilities, as a reduced manufacturing footprint lowers investment and ongoing operational expenses. As new products are introduced and old products are phased out, manufacturers must manage the impact of changes to their respective manufacturing footprint (i.e. portfolio of plants) in terms of capability (i.e. size, process technologies, etc.), capacity, and total number of plants.

Investment decisions into plant capacity and corresponding equipment for future products are made well in advance of actual product introduction, due to production line development lead-time constraints. In addition, manufacturing facility investment involves long-term decisions, which are highly sensitive to uncertainty in product demand forecasts. Manufacturing facility decisions also require estimations and some degree of knowledge as to the interaction between future products and the equipment that will be used to manufacture the products. Forecasted demand data usually considers only current and near-term product releases, as product development that may occur several years in the future is difficult to predict with reasonable accuracy. Demand data is typically derived from static, lifecycle averages without consideration as to how product demand may evolve over the life of a product manufacturing cycle. Moreover, transitions and interactions between products and manufacturing capacity for such future products are also challenging to analyze.

It would be beneficial to develop a process that supports flexible decision making for matching existing and future plant capacity to products, while looking for efficiencies through flexible planning over a portfolio of manufacturing plants. By incorporating future product development planning into the analysis, manufacturing portfolio planning could include flexibility for rapidly phasing products in and out at plants already prepared for the changeover well in advance. Manufacturing portfolio planning would further benefit from the development of an automated process that can rapidly update planning to correspond to changes in customer demand for products. Accordingly, there is a need in the art for manufacturing portfolio flexibility planning.

### BRIEF DESCRIPTION OF THE INVENTION

An embodiment of the invention includes a method for manufacturing portfolio flexibility planning. The method includes matching production needs to manufacture a plurality of products with manufacturing capabilities of plants in a manufacturing portfolio. The method also includes developing flexibility scenarios for a manufacturing portfolio flexibility plan. The flexibility scenarios include manufacturing related products at one or more identified plants in the manufacturing portfolio. The method further includes performing statistical analysis of the flexibility scenarios, and evaluating a result of the statistical analysis to determine whether the flexibility scenarios meet a success criterion. The method additionally includes updating the manufacturing portfolio per the manufacturing portfolio flexibility plan when the flexibility scenarios meet the success criterion, and outputting the manufacturing portfolio flexibility plan.

Another embodiment of the invention includes a computer program product for manufacturing portfolio flexibility planning. The computer program product includes a storage medium readable by a processing circuit and storing instructions for execution by the processing circuit for implementing a method. The method includes matching production needs to manufacture a plurality or products with manufacturing capabilities of plants in a manufacturing portfolio, and developing flexibility scenarios for a manufacturing portfolio flexibility plan. The flexibility scenarios include manufacturing related products at one or more identified plants in the manufacturing portfolio. The method also includes performing statistical analysis of the flexibility scenarios, and evaluating a result of the statistical analysis to determine whether the flexibility scenarios meet a success criterion. The method additionally includes updating the manufacturing portfolio per the manufacturing portfolio flexibility plan when the flexibility scenarios meet the success criterion, and outputting the manufacturing portfolio flexibility plan.

A further embodiment of the invention includes a system for manufacturing portfolio flexibility planning. The system includes a host system and a data storage device in communication with the host system. The data storage device holding a manufacturing portfolio. The system also includes a manufacturing portfolio flexibility planning tool (MPFPT) executing on the host system. The MPFPT includes computer instructions for matching production needs to manufacture a plurality of products with manufacturing capabilities of plants in the manufacturing portfolio, and developing flexibility scenarios for a manufacturing portfolio flexibility plan. The flexibility scenarios include manufacturing related products at one or more identified plants in the manufacturing portfolio. The MPFPT also includes computer instructions for performing statistical analysis of the flexibility scenarios, and evaluating a result of the statistical analysis to determine whether the flexibility scenarios meet a success criterion. The MPFPT also includes computer instructions for updating the manufacturing portfolio per the manufacturing portfolio flexibility plan when the flexibility scenarios meet the success criterion, and outputting the manufacturing portfolio flexibility plan.

Other methods, computer program products, and/or systems according to embodiments will be or become apparent to one with skill in the art upon review of the following drawings and detailed description. It is intended that all such additional methods, computer program products, and/or systems be included within this description, be within the scope of the present invention, and be protected by the accompanying claims.

### BRIEF DESCRIPTION OF THE DRAWINGS

Referring to the exemplary drawings wherein like elements are numbered alike in the accompanying figures:

FIG. 1 depicts an exemplary process flow that may be implemented by exemplary embodiments for manufacturing portfolio flexibility planning;

FIGS. 2A and B depict an exemplary process flow that may be implemented by exemplary embodiments for developing flexibility scenarios;

FIGS. 3A and B depict an exemplary process flow that may be implemented by exemplary embodiments for performing statistical analysis of flexibility scenarios;

FIG. 4 depicts a block diagram of an exemplary system upon which manufacturing portfolio flexibility planning may be performed;

FIG. 5 depicts an exemplary user interface that may be implemented by exemplary embodiments for developing flexibility scenario analysis case studies;

FIG. 6 depicts an exemplary user interface that may be implemented by exemplary embodiments for flexibility scenario viewing, creation, and deletion;

FIG. 7 depicts an exemplary user interface that may be implemented by exemplary embodiments for applying a flexibility scenario;

FIG. 8A and B depict an exemplary user interface that may be implemented by exemplary embodiments for viewing and/or modifying demand information for a flexibility scenario;

FIG. 9 depicts an exemplary demand profile as an annual demand reduction;

FIG. 10 depicts exemplary net present value (NPV) distributions for multiple flexibility scenarios; and

FIG. 11 depicts a graphical user interface for visualization of flexibility scenarios in accordance with exemplary embodiments.

### DETAILED DESCRIPTION OF THE INVENTION

Exemplary embodiments, as shown and described by the various figures and the accompanying text, provide methods, computer program products and systems for manufacturing portfolio flexibility planning. As a product is developed from an initial concept to a final manufactured product, a number of steps are involved. Early in the product development phase, a product concept matures into a product design architecture, and a high-level product development plan is created. The high-level product plan may specify the duration of the development period, including target completion dates for various tasks such as release to manufacturing engineering for equipment design and manufacturing process development. Furthermore, as the product design matures, more detailed planning is performed to determine specific product features and characteristics, as well as an estimated product demand. Individual product development plans may be bundled into a product portfolio plan for developing products. In exemplary embodiments, a manufacturer with multiple plants or the ability to add new plants captures such information in a manufacturing portfolio that includes a variety of information about each existing or potential manufacturing facility. An allocation between the products and the manufacturing portfolio is performed to establish which products will be manufactured at particular plants. In exemplary embodiments, planning the allocation between products and plants incorporates a flexible decision-making process that tests multiple flexibility scenarios to seek an efficient, low cost solution. A process for manufacturing portfolio flexibility planning is described in greater detail herein.

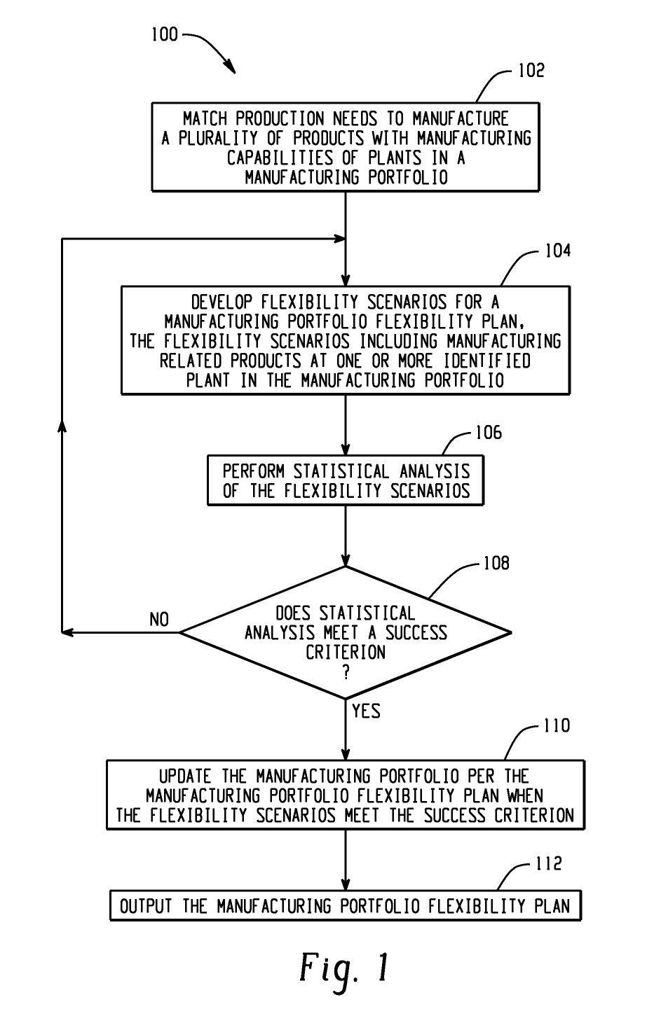

Turning now to the drawings, it will be seen that in FIG. 1 there is a process 100 for manufacturing portfolio flexibility planning. In exemplary embodiments, the process 100 is performed in response to one of: a user-initiated request, an elapsing of a planning period, a change in manufacturing capability, a change in manufacturing capacity, a change in a product portfolio, and a change in product demand. A planning period may be any period of time, such as a week, a month, a quarter year, a half year, or a full year. The product portfolio plan, including product-manufacturing characteristics, may be accessed to determine an allocation between products to manufacture and plants in the manufacturing portfolio. At block 102, production needs to manufacture multiple products are matched with manufacturing capabilities of plants in the manufacturing portfolio. For example, there may be size, feature, process, or capacity constraints that make a particular plant better suited to manufacture a particular product. Similarities between products may also be analyzed to look for common feature subsets, such as common subassemblies, to establish a preference for grouping products at a given plant. Equipment and tooling costs can be significantly reduced if multiple products with common subassemblies can be manufactured using shared equipment and tooling. Plant data may be analyzed to determine current tooling and assembly line features, as well as planned upgrades to each plant.

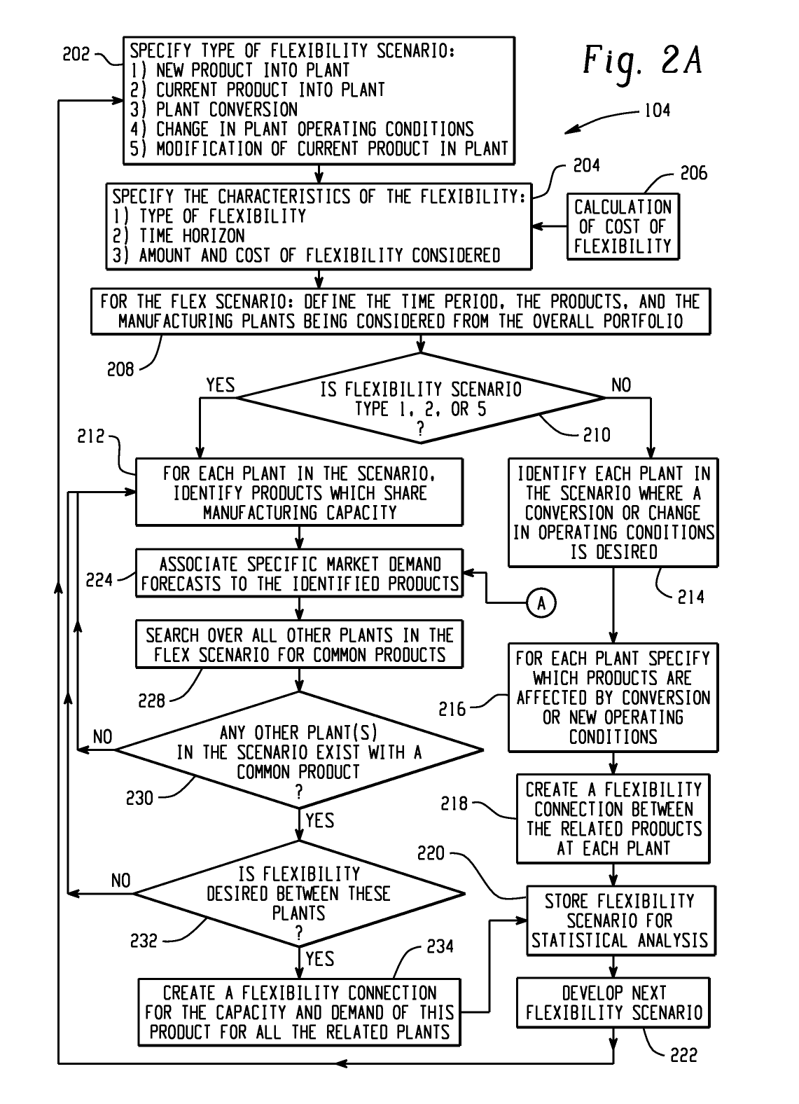

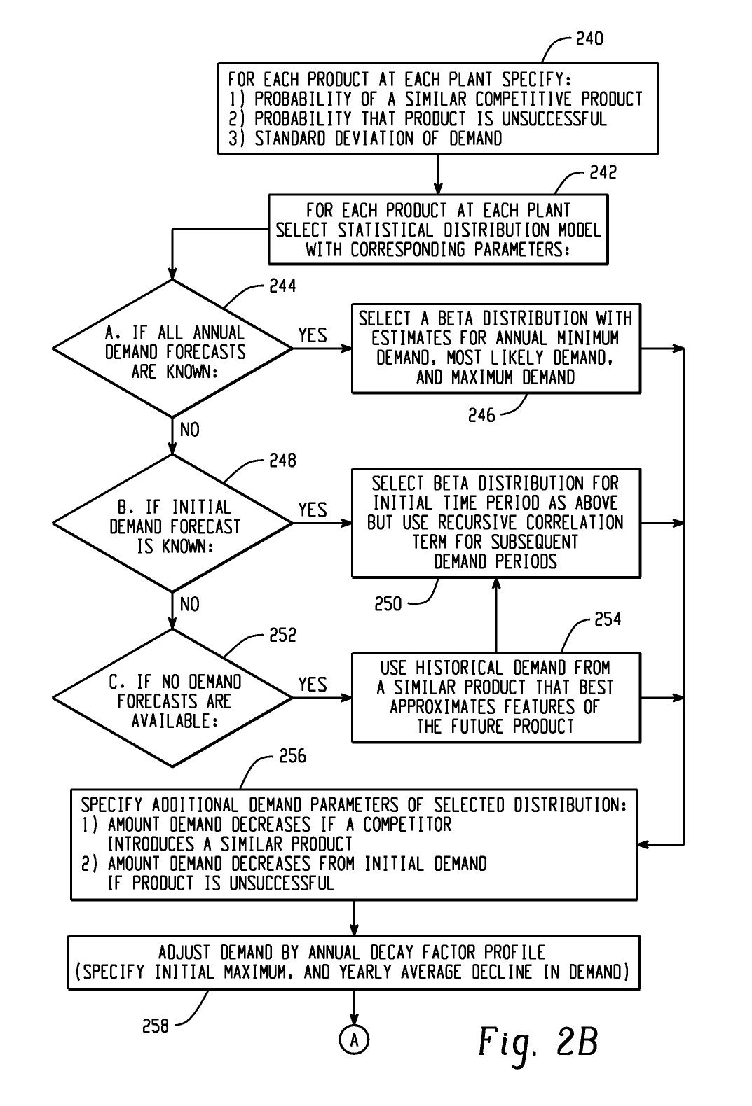

At block 104, flexibility scenarios for a manufacturing portfolio flexibility plan are developed. A flexibility scenario is a specific set of values for the characteristics and parameters that collectively define a particular configuration of the manufacturing portfolio. Flexibility scenarios may be created for the entire set of plants in the portfolio, or for a narrower subset of plants along with the corresponding products to be manufactured in such plants. At a minimum, the flexibility scenarios include manufacturing related products at one or more identified plants in the manufacturing portfolio. In exemplary embodiments, for each flexibility scenario, developing flexibility scenarios includes identifying one or more of the plants with at least one common characteristic, creating a flexibility connection between the related products at the identified plants, and storing the flexibility scenario. The common characteristic may include manufacturing capacity and market demand forecasts for specific products manufactured at each plant. Alternatively, the common characteristic may include a desired plant conversion or change in plant operating conditions. The development of flexibility scenarios is described in greater detail in reference to FIGS. 2A and 2B, provided further herein.

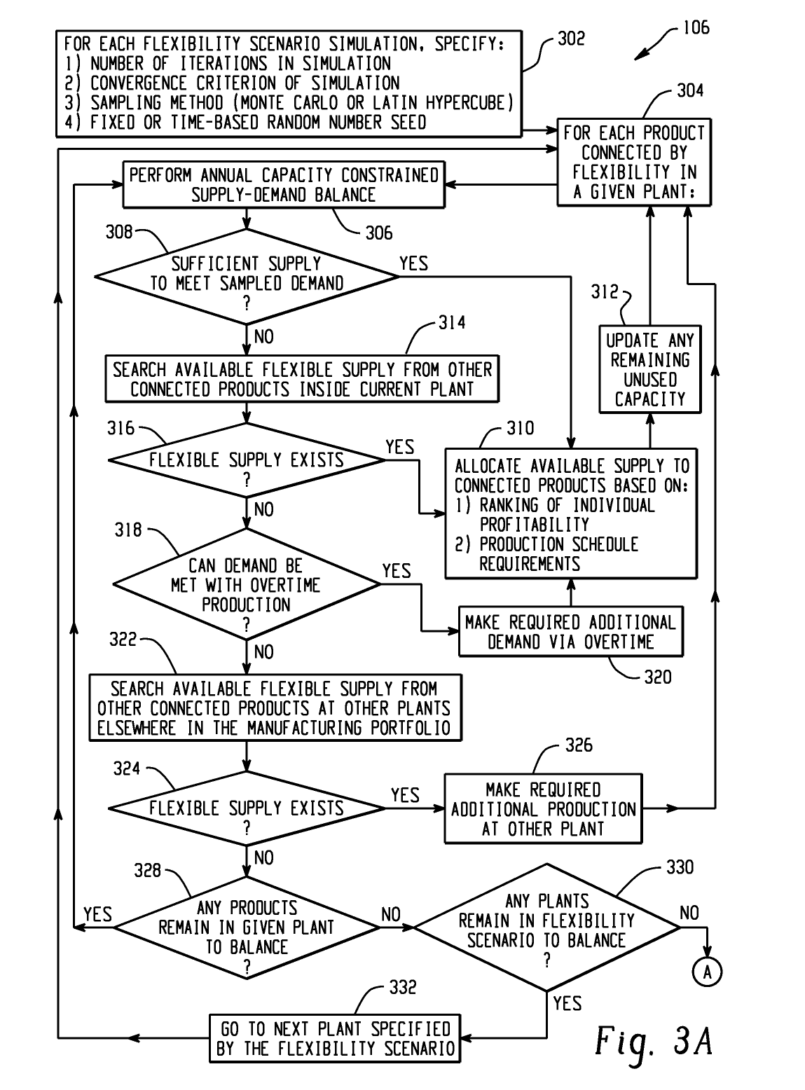

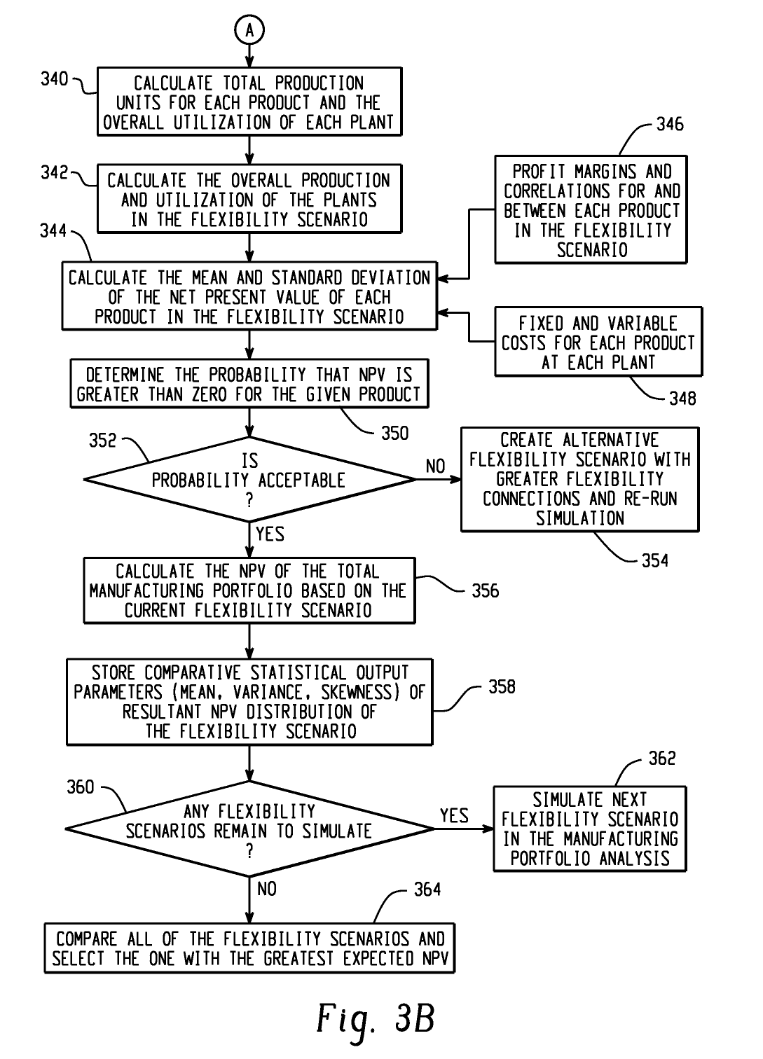

At block 106, statistical analysis of the flexibility scenarios is performed. The statistical analysis may apply a variety of probability-based calculations to establish relative chances of a successful or unsuccessful outcome for each flexibility scenario. The statistical analysis of the flexibility scenarios is described in greater detail in reference to FIGS. 3A and 3B, also provided further herein.

At block 108, a result of the statistical analysis is evaluated to determine whether the flexibility scenarios meet a success criterion. The success criterion may be defined in terms of various performance metrics. For example, optimization may be performed on seeking a solution that utilizes more than fifty percent of present plant capacity, while minimizing investment in new tooling. Alternatively, the criterion may focus on maximizing net present value of an investment in new equipment that will support manufacturing interchangeability between current and future products. When the flexibility scenarios fail to meet the success criterion, block 104 and subsequent blocks may be performed again using updated flexibility scenarios.

At block 110, when the flexibility scenarios meet the success criterion, the manufacturing portfolio is updated per the manufacturing portfolio flexibility plan. Any changes to the manufacturing portfolio may result in an update of the allocation between the one or more products and the manufacturing portfolio. The update to the manufacturing portfolio may trigger the process 100 to run again to confirm that an optimal solution has been achieved.

At block 112, the manufacturing portfolio flexibility plan is output. The output can be in a variety of formats, such as text, XML, HTML, portable document format (PDF), or similar formats. The manufacturing portfolio flexibility plan may be written to a database, a file system, or transmitted over a network. In exemplary embodiments, details of the manufacturing portfolio flexibility plan are provided to one or more suppliers. The suppliers may react to the details of the manufacturing portfolio flexibility plan by changing delivery schedules and adjusting inventory to optimize their performance as well. Suppliers could also use manufacturing portfolio flexibility planning for their own set of products and plants and more closely integrate their portfolios with those of their customers. Various decision makers can take non-automated steps based on the manufacturing portfolio flexibility plan, such as making staffing adjustments, and coordinating with parties that do not have direct access to information within the manufacturing portfolio flexibility plan.

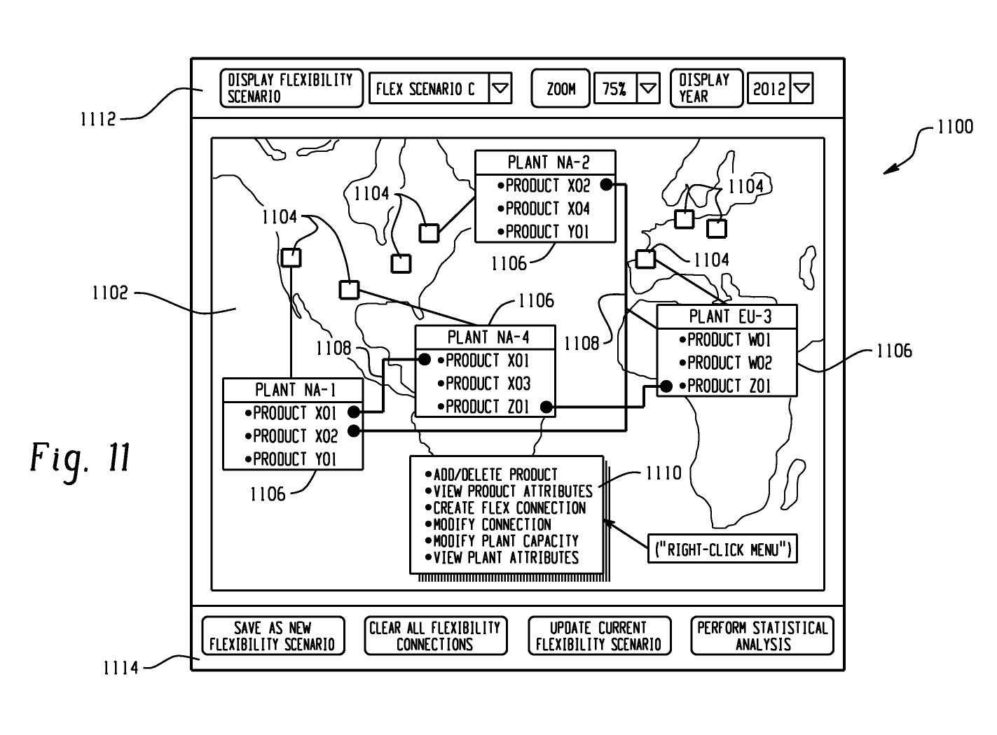

Turning now to FIG. 2A, a process of block 104 for developing flexibility scenarios is depicted in accordance with exemplary embodiments. It will be understood that the process of block 104 is merely one embodiment of the block 104 of the process 100 of FIG. 1, and should not be construed as limiting in scope for developing flexibility scenarios. Input data for the process of block 104 may be acquired via data entry or through a graphical user interface, such as the graphical user interface 1100 for visualization of flexibility scenarios, as depicted in FIG. 11. The graphical user interface 1100 of FIG. 11 may also provide a graphical output for displaying the flexibility scenarios developed using the process of block 104 for user interaction both during and after the development of the flexibility scenarios.

At block 202 of FIG. 2A, a type of flexibility scenario is selected. Exemplary flexibility scenario types include: a new product into a plant, a current product into a plant, a plant conversion, a change in plant operating conditions, and a modification of a current product in a plant. At block 204, characteristics of flexibility are selected. Exemplary characteristics of flexibility include: a type of flexibility, a time horizon, and an amount and cost of flexibility considered. At block 206, the cost of flexibility is calculated and passed as an input to block 204. The cost of flexibility may be calculated by ascertaining the additional investment required above and beyond the initial investment into current, known products. The cost of flexibility depends on the assumptions made for future product allocations. For example, if a given plant currently is assigned three products, then one flexibility scenario may require calculating the costs associated with producing a fourth product at the same plant. A different flexibility scenario could examine five products at the same plant, which would in turn have a different cost of flexibility. The actual cost of flexibility may be made up of different sources. These cost elements typically include items such as additional tooling, equipment, floor space, material handling devices and containers, and even additional labor. There are many different ways to determine these actual costs. Traditionally, costs are calculated by analyzing the assembly process and then determining the corresponding equipment and tooling required to carry out the product assembly. The determination of costs requires knowledge of whether or not any given piece of equipment can produce multiple related products. Starting with knowledge of the product assembly process, the calculation of flexibility cost then is a matter of summing up all of the additional investments into the various cost elements.

At block 208, attributes for the selected flexibility scenario are defined such as a time period, products, and manufacturing plants under consideration from the manufacturing portfolio. It will be understood that within the scope of the invention there may be other selectable flexibility scenario types and characteristics of flexibility, as well as definable parameters for the flexibility scenario other than the examples provided in FIG. 2A.

At block 210, the type of flexibility scenario is checked. In exemplary embodiments, if the flexibility scenario is product focused, block 212 is performed; otherwise, block 214 is performed. Examples of product focused flexibility scenarios include: a new product into a plant, a current product into a plant, and a modification of a current product in a plant. Conversely, plant focused flexibility scenarios may include a plant conversion and a change in plant operating conditions.

At block 214, each plant in the scenario is identified where a conversion or change in operating conditions is desired. At block 216, for each plant, products affected by conversion or new operating conditions are specified. At block 218, a flexibility connection between the related products at each plant is created. A flexibility connection is the specification that two or more products are similar such that they can share capacity either at a single or at multiple plants (if the similar products are not at the same plant). A logical association between products is created that allows their respective demands to be fulfilled from their shared capacity. At block 220, the flexibility scenario is stored for the statistical analysis process of block 106 of FIG. 1. At block 222, the process loops back to block 202, creating additional flexibility scenarios.

Returning now to block 212, for each plant in the flexibility scenario, products that share manufacturing capacity are identified. At block 224, specific market demand forecasts are associated to the identified products. In exemplary embodiments, block 224 receives demand parameters from block 258 of FIG. 2B. At block 228, other plants in the flexibility scenario are searched for common products. At block 230, if any other plant or plants in the flexibility scenario exist with a common product, then block 232 is performed; otherwise, block 212 is performed again. At block 232, if flexibility is desired between plants with a common product, then block 234 is performed; otherwise, block 212 is performed again. At block 234, a flexibility connection for the capacity and demand of the product is created for all related plants, and block 220 is performed.

Turning now to FIG. 2B, at block 240 demand parameters may be specified for each product at each plant. Exemplary demand parameters include: a probability of a similar competitive product, a probability that the product is unsuccessful, and a standard deviation of demand. It will be understood that additional demand parameters can be utilized within the scope of the invention. At block 242, a statistical distribution model of possible outcomes of demand values with corresponding parameters is selected for each product at each plant. At block 244, if all annual demand forecasts are known, then block 246 is performed; otherwise, block 248 is performed. It will be understood that other types of statistical distributions for customer demand can be utilized within the scope of the invention. At block 246, a beta distribution with estimates for an annual minimum demand, a most likely demand, and a maximum demand is selected. At block 248, if an initial demand forecast is known, then block 250 is performed; otherwise, block 252 is performed. At block 250, a beta distribution for an initial time period is selected, similar to block 246, but a recursive correlation term is used for subsequent demand periods. Demand correlation is an important parameter to incorporate as part of the statistical analysis since customer demand needs to be related from one time period to the next and is needed to accurately represent historical behavior and trends. At block 252, if no demand forecasts are available, then block 254 is performed. At block 254, a historical demand from a similar product that best approximates features of the future product is utilized. At block 256, additional demand parameters of the selected distribution are specified. Exemplary additional demand parameters may include an amount demand decreases if a competitor introduces a similar product and an amount demand decreases from initial demand if the product is unsuccessful. At block 258, demand may be adjusted by an annual decay factor profile, accounting for factors such as an initial maximum and a yearly average decline in demand. As previously described, block 258 may provide inputs for block 224 of FIG. 2A to associate the specific market demand forecasts to the identified products. In summary, applying the process depicted in FIGS. 2A and 2B, a variety of flexibility scenarios can be constructed and analyzed to determine how the manufacturing portfolio flexibility plan should be updated.

Turning now to FIG. 3A, a process of block 106 for performing statistical analysis of flexibility scenarios is depicted in accordance with exemplary embodiments. It will be understood that the process of block 106 is merely one embodiment of the block 106 of the process 100 of FIG. 1, and should not be construed as limiting in scope for performing statistical analysis of flexibility scenarios. At block 302, flexibility scenario simulation parameters are assigned for each simulation. Exemplary flexibility scenario simulation parameters include; a number of iterations in a simulation, a convergence criterion of simulation, a sampling method (e.g., Monte Carlo or Latin Hypercube methods), and a fixed or time-based random number seed. At block 304, each product connected by flexibility in a given plant is identified for analysis. At block 306, annual capacity constrained supply-demand balancing is performed. Balancing may alternatively be performed on other periods, such as weekly, monthly, quarterly, semi-annually, or bi-annually. At block 308, if there is sufficient supply to meet sampled demand, then block 310 is performed; otherwise, block 314 is performed. At block 310, an allocation of available supply to connected products is performed. The allocation may be based on ranking of individual profitability, production schedule requirements, or other factors. At block 312, any remaining unused capacity is updated, and block 304 is performed again.

At block 314, a search of available flexible supply from other connected products inside of the given plant under analysis is performed. At block 316, if flexible supply exists, then block 310 is performed; otherwise, block 318 is performed. At block 318, if demand can be met with overtime production, then block 320 is performed; otherwise, block 322 is performed. At block 320, additional demand is made via overtime. At block 322, a search of available flexible supply from other connected products at other plants elsewhere in the manufacturing portfolio is performed. At block 324, if a flexible supply exists, then block 326 is performed; otherwise, block 328 is performed. At block 326, additional production is made at another plant with flexible supply, and block 304 is performed, again. At block 328, if any products remain in the given plant to balance, then block 306 is performed again; otherwise, block 330 is performed. At block 330, if any plants remain in the flexibility scenario to balance, then block 332 is performed; otherwise, block 340 of FIG. 3B is performed. At block 332, the next plant specified in the flexibility scenario is selected for analysis as the new given plant, and block 304 is performed again.

Turning now to FIG. 3B, in block 340, total production units for each product and the overall utilization of each plant are calculated. At block 342, the overall production and utilization of the plants in the flexibility scenario are calculated. At block 344, a mean and standard deviation of a net present value (NPV) of each product in the flexibility scenario are calculated. The calculations performed in block 344 receive inputs from blocks 346 and 348. In exemplary embodiments, block 346 provides profit margins and correlations for and between each product in the flexibility scenario, and block 348 provides fixed and variable costs for each product at each plant. At block 350, the probability that the NPV is greater than zero for the given product is determined. At block 352, if the probability is considered acceptable, then block 356 is performed; otherwise, block 354 is performed. The determination as to whether the probability is acceptable may be performed as a comparison to a programmable threshold value, for example, a probability of greater than 50%. At block 354, an alternative flexibility scenario is created with greater flexibility connections and the simulation is re-run. At block 356, the NPV of the total manufacturing portfolio based on the current flexibility scenario is calculated. At block 358, comparative statistical output parameters (e.g., mean, variance, skewness) of the calculated NPV distribution of the flexibility scenario are stored. At block 360, if any flexibility scenarios remain to simulate, then block 362 is performed; otherwise, block 364 is performed. At block 362, the next flexibility scenario in the manufacturing portfolio is selected for simulation and analysis.

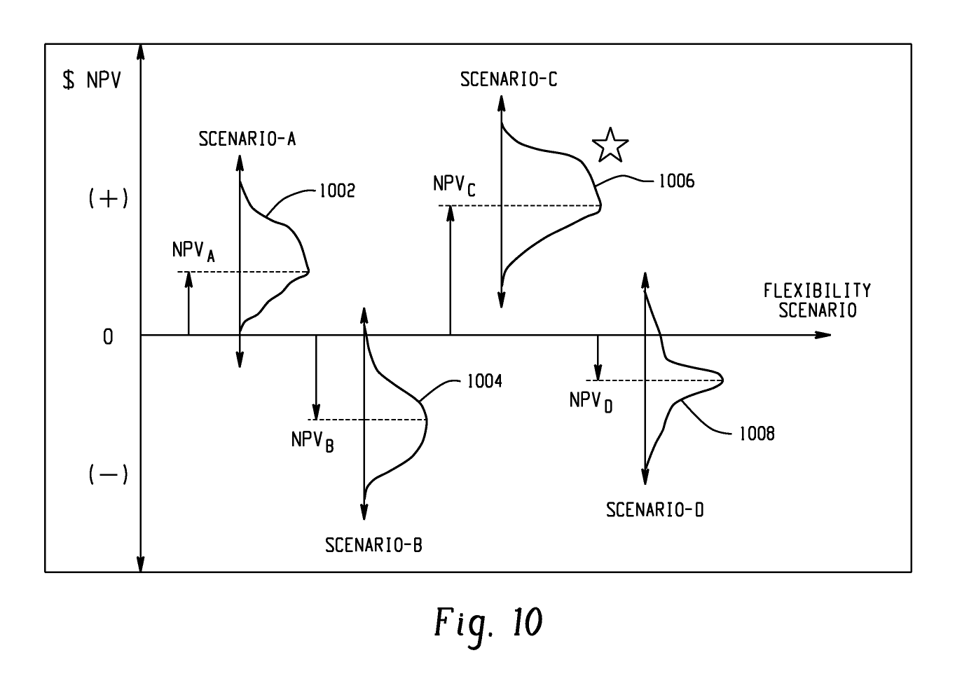

At block 364, all of the flexibility scenarios are compared, and the flexibility scenario with the greatest expected NPV is selected. This is graphically depicted through the example illustrated in FIG. 10. FIG. 10 shows four exemplary flexibility scenario distributions, scenario-A 1002, scenario-E 1004, scenario-C 1006, and scenario-D 1008, each with varying NPVs. As can be seen in FIG. 10, since the expected NPV of the scenario-C 1006 has the largest positive value, scenario-C 1006 is selected.

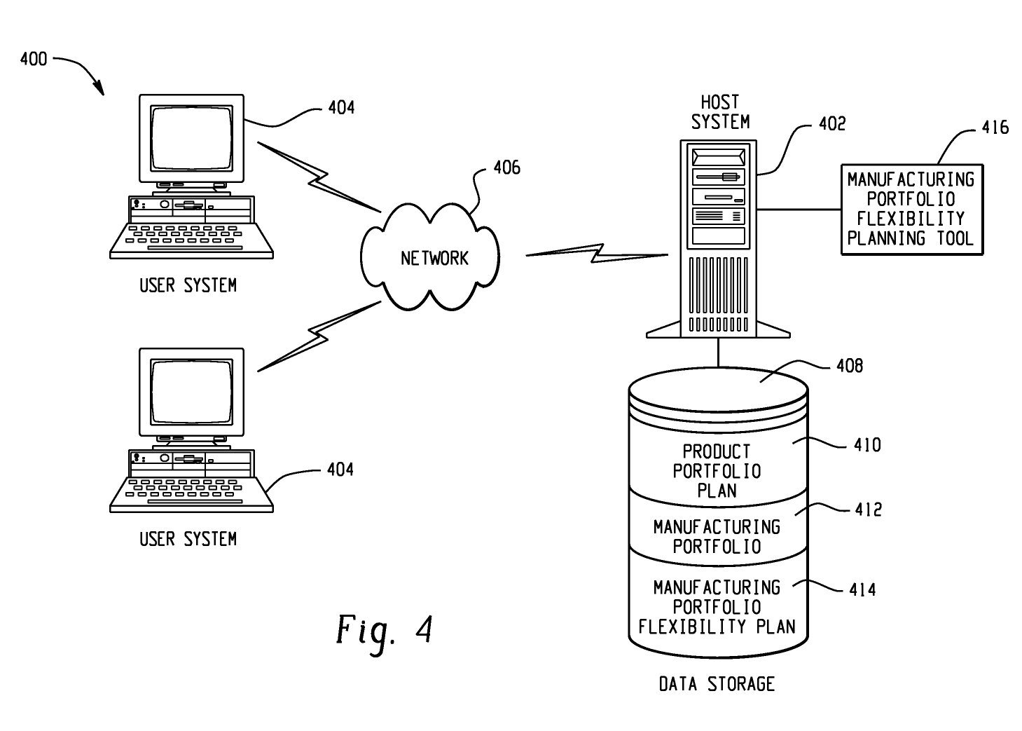

Turning now to FIG. 4, a block diagram of a system 400 is depicted upon which manufacturing portfolio flexibility planning is implemented in exemplary embodiments. The system 400 of FIG. 4 includes a host system 402 in communication with user systems 404 over a network 406. The host system 402 may be a high-speed processing device (e.g., a mainframe computer) including at least one processing circuit (e.g., a CPU) capable of reading and executing instructions, and handling large volumes of processing requests from user systems 404. In exemplary embodiments, the host system 402 functions as an application server, a database management server, and a web server. User systems 404 may comprise desktop or general-purpose computer devices that generate data and processing requests via a graphical or text-based user interface. While only a single host system 402 is shown in FIG. 4, it will be understood that multiple host systems can be implemented, each in communication with one another via direct coupling or via one or more networks. For example, multiple host systems may be interconnected through a distributed network architecture. The single host system 402 may also represent a cluster of hosts collectively performing processes as described in greater detail herein.

The network 406 may be any type of communications network known in the art. For example, The network 406 may be an intranet, extranet, or an internetwork, such as the internet, or a combination thereof. The network 406 can be a wireless, wired, or fiber optic network.

In exemplary embodiments, the host system 402 accesses and stores information to a data storage device 408. The data storage device 40S refers to any type of storage and may comprise a secondary storage element, e.g., hard disk drive, tape, or a storage subsystem that is external to the host system 402. In alternate exemplary embodiments, the data storage device 408 is internal to the host system 402. It will be understood that the data storage device 408 shown in FIG. 4 is provided for purposes of simplification and ease of explanation and is not to be construed as limiting in scope. To the contrary, there may be any number data storage devices 408 accessible by the host system 402. The data storage device 40S may hold a product portfolio plan 410, a manufacturing portfolio 412, and a manufacturing portfolio flexibility plan 414.

In exemplary embodiments, the product portfolio plan 410 holds product-manufacturing characteristics. Product manufacturing characteristics may include quantity, size, pricing targets, parts lists, sub-assembly lists, and cross-compatibility information as related to other products. The product portfolio plan 410 may also include scheduling information for starting and completing production for various products.

In exemplary embodiments, the manufacturing portfolio 412 holds capacity, capability, and geographic information for manufacturing plants. The manufacturing portfolio 412 is analyzed relative to the product portfolio plan 410 to develop a manufacturing portfolio flexibility plan 414. The host system 402 executes computer instructions embodied in a manufacturing portfolio flexibility planning tool (MPFPT) 416 to create and/or modify the manufacturing portfolio flexibility plan 414. In exemplary embodiments, the MPFPT 416 includes computer executable instructions to perform the process 100 of FIG, 1. The MPFPT 416 may be a stand-alone application, a plug-in, a module, or an executable script. In exemplary embodiments, a user of the user systems 404 initiates execution of the MPFPT 416 and receives the resulting output. Alternatively, the user systems 404 may execute any portion of the MPFPT 416, e.g., a distributed computing architecture.

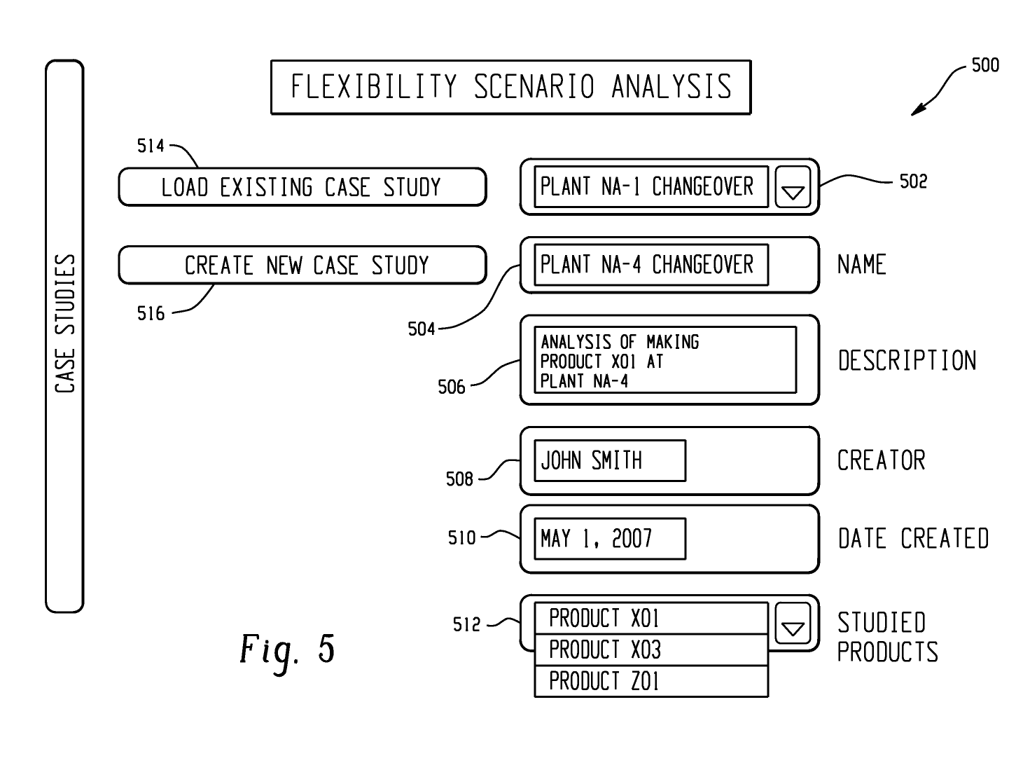

Turning now to FIG. 5, an exemplary user interface 500 is depicted for developing flexibility scenario analysis case studies using the MPFPT 416 of FIG. 4, as may be accessed by the user systems 404. In exemplary embodiments, the user interface 500 includes a case study selection input box 502, a case study name input box 504, a description input box 506, a creator input box 508, a date created input box 510, and a studied products selection input box 512. Although the input boxes 502-512 are referred to as “input boxes”, some boxes may be read-only information that is automatically filled in with existing data or determined on the fly, e.g., date created input box 510. Moreover, the user interface 500 represents an exemplary embodiment, and should not be construed as limiting in scope. In exemplary embodiments, the user interface 500 also includes command buttons 514 and 516. The command button 514 may load an existing case study from the data storage device 408 of FIG. 4, and the command button 516 can create a new case study.

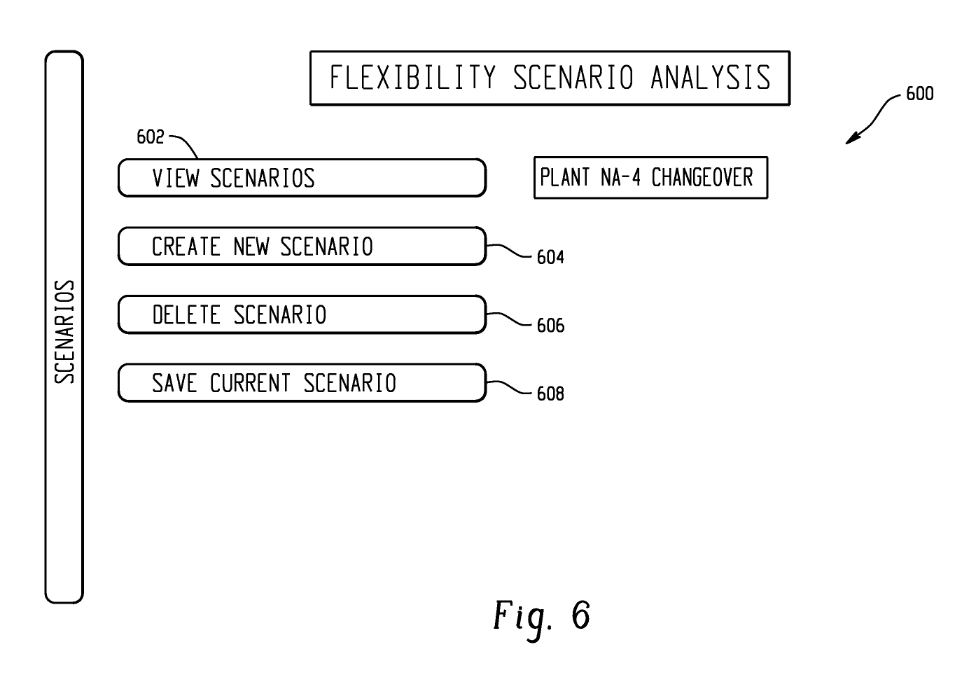

The case studies accessed through the user interface 500 may include multiple flexibility scenarios. FIG. 6 depicts an exemplary user interface 600 than includes several command buttons associated with viewing, creating, deleting, and saving flexibility scenarios. The command button 602 can be selected to view one or more flexibility scenarios. The command button 604 may create a new flexibility scenario, while command button 606 deletes a flexibility scenario. The current flexibility scenario can be saved using command button 608.

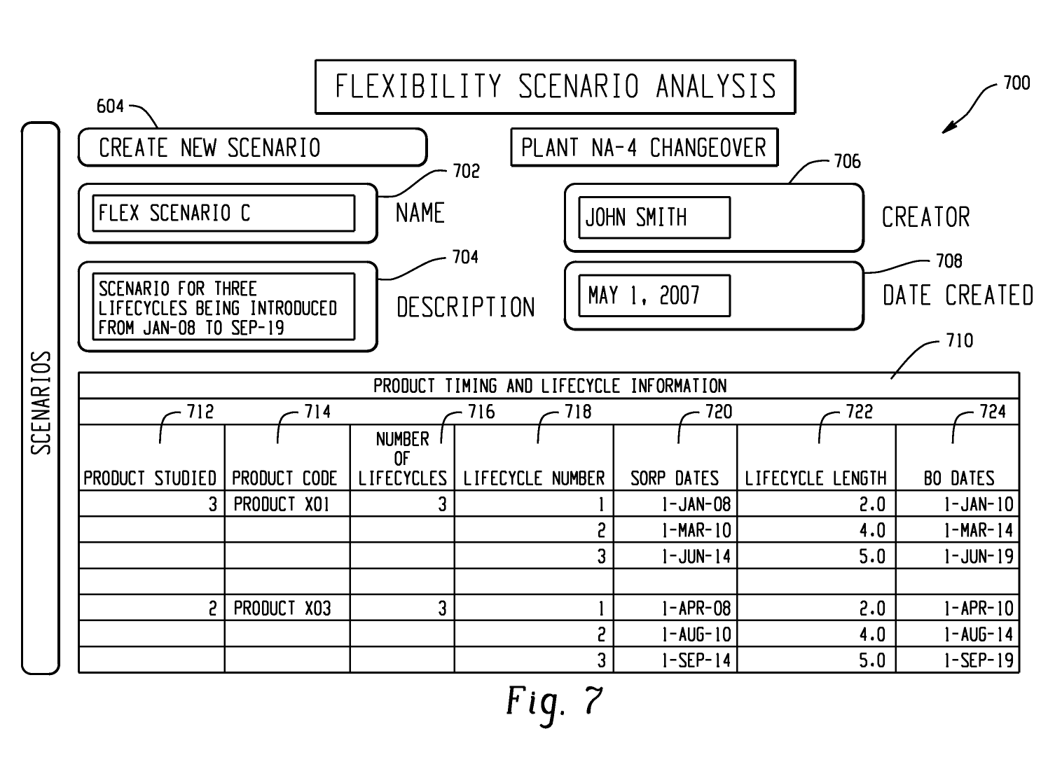

FIG. 7 depicts an exemplary user interface 700 for applying a flexibility scenario, including data associated with the flexibility scenario. The data may include a flexibility scenario name 702, a flexibility scenario description 704, a flexibility scenario creator 706, a flexibility scenario date of creation 708, and product timing and lifecycle information 710. In exemplary embodiments, the user interface 700 also includes the command button 604 to create a new flexibility scenario. The product timing and lifecycle information 710 may include a number of fields that further define the parameters for the flexibility scenario. In exemplary embodiments, the product timing and lifecycle information 710 includes fields for product studied 712, product code 714, number of lifecycles 716, lifecycle number 718, start of regular production (SORP) dates 720, lifecycle length 722, and build out (BO) dates 724. A SORP date refers to a point in time when a plant is efficiently producing at its target production rate and meeting quality objectives. Prior to the SORP date, the plant may be producing products at a slower rate, as new systems are being calibrated and initial products are validated to ensure that requirements are met. A BO date refers to a date up to which a given product is made, and after which time the given product is no longer produced. Other fields specific to each flexibility scenario may be created and viewed.

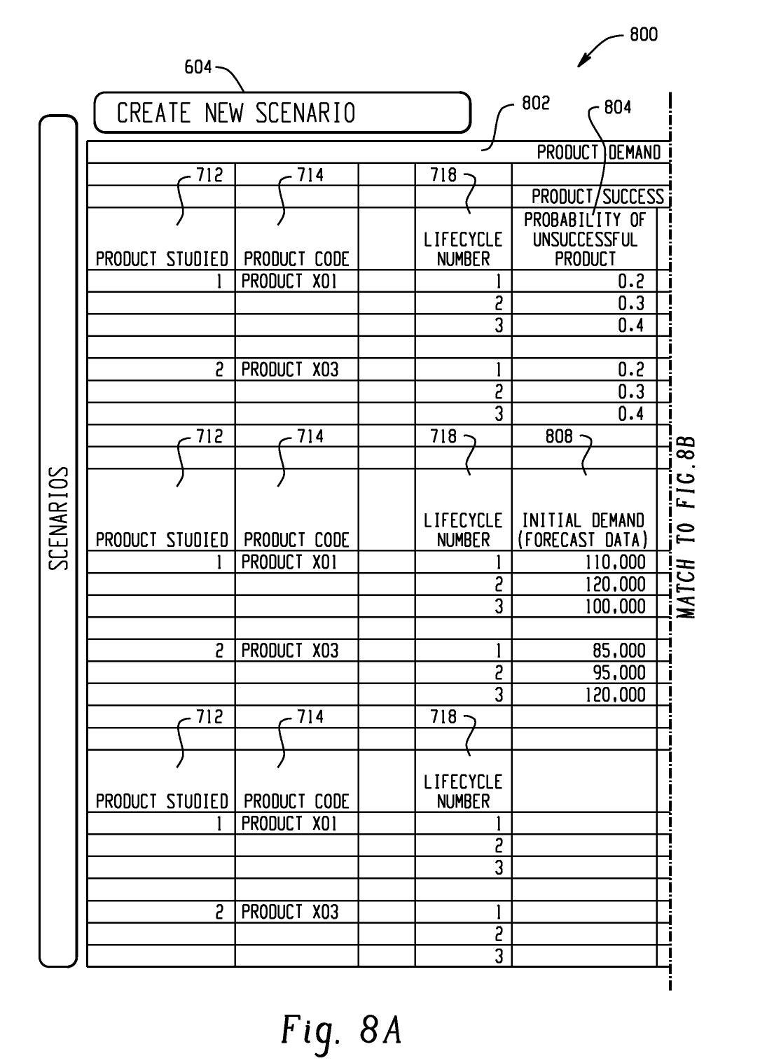

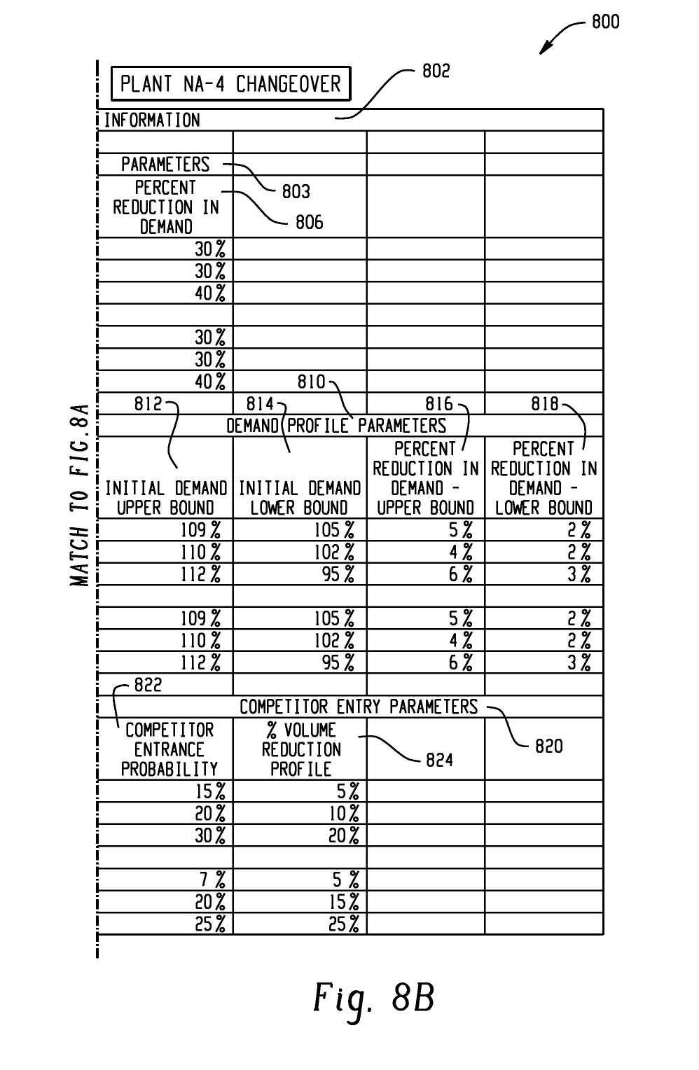

FIGS. 8A and B depict an exemplary user interlace 800 for viewing and/or modifying demand information for a flexibility scenario. The user interface 800 may enable product demand information 802 associated with the exemplary flexibility scenario of FIG. 7 to be viewed, updated, and/or further analyzed. In exemplary embodiments, the product demand information 802 includes fields for product studied 712, product code 714, and lifecycle number 718, as depicted in FIG. 7. The product demand information 802 may also include product success parameters 803, such as a probability of unsuccessful product 804 and an associated percent reduction in demand 806, for the given lifecycle number 718. The lifecycle number 718 may also be associated with an initial demand 808 and demand profile parameters 810. In exemplary embodiments, the demand profile parameters 810 include an initial demand upper bound 812, an initial demand lower bound 814, a percent reduction in demand upper bound 816, and a percent reduction in demand lower bound 818.

The lifecycle number 718 may further be associated with competitor entry parameters 820. In exemplary embodiments, the competitor entry parameters 820 include a competitor entrance probability 822 and a percent volume reduction profile 824. The use of the competitor entry parameters 820 may enable impact planning for the effects of a competitor's product on a planned product to manufacture. For example, a new competitor product may be launched at any time in the lifecycle of the planned product to manufacture. But, the success of the planned product may be assumed to be constant for the entire duration of the product's lifecycle. In other words, it is assumed that if a product is well received by consumers at its introduction (and hence successful), then it will continue in this state of customer favor for the remainder of the lifecycle. The converse may also be true for unsuccessful products.

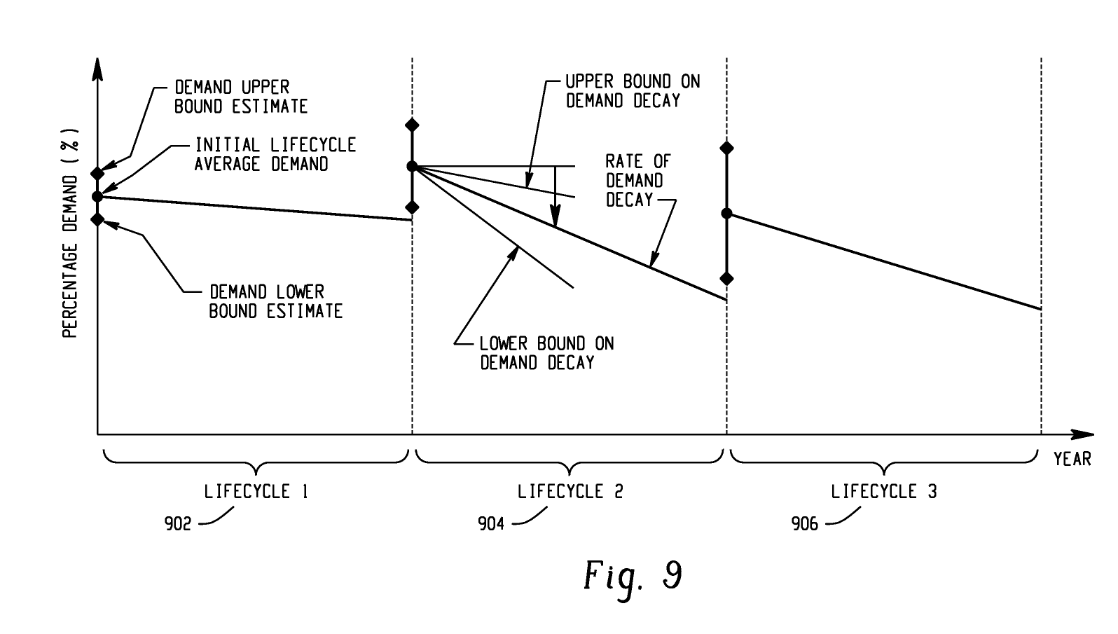

In exemplary embodiments, the percent volume reduction profile 824, as well as the percent reduction in demand upper bound 816 and lower bound 818, are used to represent the general decay or “ageing” of the product in the marketplace as initial customer interest and enthusiasm diminishes as time progresses. More innovative products may have a slower rate of decay. The percent reduction in demand upper bound 816 and lower bound 818 may be used in cases where only initial demand estimates are known (e.g., annual demand). If complete estimates are known of demand over the lifecycle of a flexibility scenario, then these may be used in the calculation of probabilistic demand. An example of a demand profile with demand reduction is depicted in FIG. 9, illustrating annual demand reductions over multiple lifecycles 902, 904, and 906. Note that the demand profile represents the underlying direction or trend in customer demand. The actual demand values generated during the simulation can be above or below the profile depending on the random number used in any given iteration of the simulation.

Turning now to FIG. 11, a graphical user interface 1100 for visualization of flexibility scenarios is depicted in accordance with exemplary embodiments, as may be accessed by the user systems 404 of FIG. 4. The graphical user interface 1100 may enable the creation and modification of flexibility scenarios in a graphical format, enhancing understanding and ease of use. In exemplary embodiments, the graphical user interface 1100 includes a geographic map 1102 including plant locations 1104. Plant product lists 1106 associated with the plant locations 1104 are also included. Flexibility connections 1108 between products within the plant product lists 1106 illustrate the relationships between products at various plants forming a flexibility scenario. The flexibility connections 1108 may be created by selecting a product from one of the plant product lists 1106 and then dragging the product over to another plant product list 1106, where the product is then added and updated to the manufacturing portfolio plan. If there are plant constraints where the product is being dragged to that prevent the product from being manufactured at a targeted plant, the graphical user interface 1100 can notify a user that this is an invalid flexibility connection. The graphical user interface 1100 may provide further detailed information about the constraint preventing the flexibility connection from being created. Menu box 1110 depicts an exemplary menu of options that may be visible to a user upon right-clicking on the graphical user interface 1100 using a mouse or similar peripheral input device. In exemplary embodiments, an upper input region 1112 and a lower input region 1114 are included to support modifying display characteristics, performing statistical analysis, saving the flexibility scenario, and the like. Using the graphical user interface 1100, plant capacity and other supply constraints that limit flexibility scenarios can be simultaneously displayed, thus allowing for faster creation and storage of feasible alternatives. Graphical images of flexibility scenarios can be readily exported and communicated to other analysts and users for collaborative planning of the manufacturing portfolio. Multiple time periods may be displayed quickly in rapid succession to emphasize year-over-year changes. Using the graphical user interface 1100, a graphical representation of flexibility scenarios may enhance a user's understanding of the manufacturing portfolio plan, which can be helpful for decision-makers in comparing one scenario to another prior to performing statistical analysis.

Technical effects and advantages of exemplary embodiments include manufacturing portfolio planning with enhanced flexibility. Through manufacturing portfolio flexibility planning, decisions can be made to support optimizing the allocation of products to plants for both current and future demand predictions, thus lowering total manufacturing cost. Performing manufacturing portfolio flexibility planning as an automated process enables multiple iterations to test various flexibility scenarios, optimizing the result on one or more selectable criteria. In addition, the use of computer-based tools for manufacturing portfolio flexibility planning enables more efficient and rapid creation of a larger and broader set of flexibility scenarios than could otherwise be generated by manual methods. A manufacturing portfolio flexibility plan may give suppliers and other business partners information that they need to keep costs down, matching inventory and distribution with planned manufacturing activities. Performing manufacturing portfolio flexibility planning as an automated process may also support a rapid response to changing market conditions that impact demand in a previously unpredicted manner, for example, a spike in fuel cost diminishing sport utility vehicle sales while increasing compact vehicle sales.

An embodiment of the invention may be embodied in the form of computer-implemented processes and apparatuses for practicing those processes. The present invention may also be embodied in the form of a computer program product having computer program code containing instructions embodied in tangible media, such as floppy diskettes, CD-ROMs, hard drives, universal serial bus (USB) flash drives, or any other computer readable storage medium, such as read-only memory (ROM), random access memory (RAM), and erasable-programmable read only memory (EPROM), for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for manufacturing portfolio flexibility planning comprising;
matching production needs to manufacture a plurality of products with manufacturing capabilities of plants in a manufacturing portfolio;
developing flexibility scenarios for a manufacturing portfolio flexibility plan, the flexibility scenarios including manufacturing related products at one or more identified plants in the manufacturing portfolio;
performing statistical analysis of the flexibility scenarios;
evaluating a result of the statistical analysis to determine whether the flexibility scenarios meet a success criterion;
updating the manufacturing portfolio per the manufacturing portfolio flexibility plan when the flexibility scenarios meet the success criterion; and
outputting the manufacturing portfolio flexibility plan.

2. The method of claim 1 further comprising:
allocating the plurality of products to the manufacturing portfolio; and
updating the allocation of the plurality of products to the manufacturing portfolio when the manufacturing portfolio is updated.

3. The method of claim 1 further comprising;
accessing a product portfolio plan, the product portfolio plan including product manufacturing characteristics for the matching or the production needs to manufacture the plurality of products with the manufacturing capabilities of the plants in the manufacturing portfolio.

4. The method of claim 1 wherein developing flexibility scenarios further comprises, for each flexibility scenario:
identifying one or more of the plants with at least one common characteristic;
creating a flexibility connection between the related products at the one or more identified plants; and
storing the flexibility scenario.

5. The method of claim 1 wherein performing statistical analysis of the flexibility scenarios further comprises:
calculating statistical parameters of net present value (NPV) of the flexibility scenarios.

6. The method of claim 1 further comprising:
updating the flexibility scenarios for the manufacturing portfolio flexibility plan when the flexibility scenarios fail to meet the success criterion.

7. The method of claim 1 wherein details of the manufacturing portfolio flexibility plan are provided to one or more suppliers.

8. The method of claim 1 further comprising:
performing the method in response to one of: an elapsing of a planning period, a change in manufacturing capability, a change in manufacturing capacity, a change in a product portfolio, and a change in product demand.

9. A computer program product for manufacturing portfolio flexibility planning, the computer program product comprising:
a storage medium readable by a processing circuit and storing instructions for execution by the processing circuit for implementing a method, the method comprising:
matching production needs to manufacture a plurality of products with manufacturing capabilities of plants in a manufacturing portfolio;
developing flexibility scenarios for a manufacturing portfolio flexibility plan, the flexibility scenarios including manufacturing related products at one or more identified plants in the manufacturing portfolio;
performing statistical analysis of the flexibility scenarios;
evaluating a result of the statistical analysis to determine whether the flexibility scenarios meet a success criterion;
updating the manufacturing portfolio per the manufacturing portfolio flexibility plan when the flexibility scenarios meet the success criterion; and
outputting the manufacturing portfolio flexibility plan.

10. The computer program product of claim 9 further comprising:
allocating the plurality of products to the manufacturing portfolio; and
updating the allocation of the plurality of products to the manufacturing portfolio when the manufacturing portfolio is updated.

11. The computer program product of claim 9 further comprising:
updating the flexibility scenarios for the manufacturing portfolio flexibility plan when the flexibility scenarios fail to meet the success criterion.

12. The computer program product of claim 9 wherein developing flexibility scenarios further comprises, for each flexibility scenario:
identifying one or more of the plants with at least one common characteristic;
creating a flexibility connection between the related products at the one or more identified plants;
storing the flexibility scenario; and
outputting the flexibility scenario with the flexibility connection to a graphical display.

13. A system for manufacturing portfolio flexibility planning, comprising:
a host system;
a data storage device in communication with the host system, the data storage device holding a manufacturing portfolio; and
a manufacturing portfolio flexibility planning tool (MPFPT) executing on the host system, the MPFPT including computer instructions for performing:
matching production needs to manufacture a plurality of products with manufacturing capabilities of plants in the manufacturing portfolio;
developing flexibility scenarios for a manufacturing portfolio flexibility plan, the flexibility scenarios including manufacturing related products at one or more identified plants in the manufacturing portfolio;
performing statistical analysis of the flexibility scenarios;
evaluating a result of the statistical analysis to determine whether the flexibility scenarios meet a success criterion;
updating the manufacturing portfolio per the manufacturing portfolio flexibility plan when the flexibility scenarios meet the success criterion; and
outputting the manufacturing portfolio flexibility plan.

14. The system of claim 13 wherein the MPFPT further performs:
allocating the plurality of products to the manufacturing portfolio; and
updating the allocation of the plurality of products to the manufacturing portfolio when the manufacturing portfolio is updated.

15. The system of claim 9, wherein the data storage device further includes a product portfolio plan, the product portfolio plan including product manufacturing characteristics for the matching of the production needs to manufacture the plurality of products with the manufacturing capabilities of the plants in the manufacturing portfolio.

16. The system of claim 13 wherein developing flexibility scenarios further comprises, for each flexibility scenario:
identifying one or more of the plants with at least one common characteristic;
creating a flexibility connection between the related products at the one or more identified plants;
storing the flexibility scenario; and
outputting the flexibility scenario with the flexibility connection to a graphical display.

17. The system of claim 13 wherein the performing statistical analysis of the flexibility scenarios further comprises:
calculating statistical parameters of net present value (NPV) of the flexibility scenarios.

18. The system of claim 13 wherein the MPFPT further performs:
updating the flexibility scenarios for the manufacturing portfolio flexibility plan when the flexibility scenarios fail lo meet the success criterion.

19. The system of claim 13 wherein details of the manufacturing portfolio flexibility plan are provided to one or more suppliers

20. The system of claim 13 wherein the MPFPT performs in response to one of: an elapsing of a planning period, a change in manufacturing capability, a change in manufacturing capacity, a change in a product portfolio, and a change in product demand.
